(19) United States
(12) Patent Application Publication
(10) Pub. No.: US 2011/0003156 A1
(43) Pub. Date: Jan. 6, 2011

(54) Core-Shell Type Cobalt Oxide Microparticle or Dispersion Containing the Microparticle, and Production Process and Use of the Microparticle or the Dispersion

(76) Inventors: Noriya Izu, Aichi (JP); Ichiro Matsubara, Aichi (JP); Toshio Itoh, Aichi (JP); Woosuck Shin, Aichi (JP); Maiko Nishibori, Aichi (JP)

Correspondence Address: SUZANNAH K. SUNDBY;SMITH, GAMBRELL & RUSSEL, LLP, 1130 Connecticut Avenue, NW, Suite 1130, WASHINGTON, DC, 20036, US

(21) Appl. No.: 12/865,427

(22) PCT Filed: Feb. 6, 2009
(86) PCT No.: PCT/JP2009/052085

§ 371 Date: Aug. 11, 2010

(30) Foreign Application Priority Data
Feb. 7, 2008 (JP) 2008-027187

(51) Int. Cl. B32B 5/16; B01J 13/02

(52) U.S. Cl. 428/407; 427/213.36

(57) ABSTRACT

The objects of the present invention are to provide core-shell type cobalt oxide microparticles, a dispersion containing such microparticles, and a production process and uses of the microparticles and the dispersion, and the invention is directed at: core-shell type cobalt oxide microparticles having an average particle diameter of from 50 to 200 nm, wherein the core is a secondary particle of spherical shape to a surface of which an organic polymer is attached as the shell; a dispersion of such cobalt oxide microparticles; a dry powder obtained from such a cobalt oxide microparticle dispersion; a process for producing core-shell type cobalt oxide microparticles or a dispersion thereof, which process includes the steps of: mixing together a cobalt salt and an organic polymer in an organic solvent so as to obtain a mixture; and heating/refluxing the mixture at a predetermined temperature so as to cause core-shell type cobalt oxide microparticles to precipitate, wherein the cobalt salt is cobalt acetate; and uses of the cobalt oxide microparticles, the dispersion and the dry powder.

### TECHNICAL FIELD

The present invention relates to core-shell type cobalt oxide microparticles, a dispersion containing such microparticles, and a production process and uses of the microparticles or the dispersion. The invention relates more particularly to core-shell type cobalt oxide microparticles capable of being used in products such as pigments and catalysts, to a dispersion containing such microparticles, to a process for producing such cobalt oxide microparticles or a dispersion containing the microparticles for the purpose of manufacturing such products, and to such products. This invention provides core-shell type cobalt oxide microparticles which have a spherical shape, a particle diameter of about 50 to 200 nm and a small particle size distribution (standard deviation of particle diameter), wherein the core portion is a secondary particle that also is spherical and of uniform size, and which have a good dispersibility in a liquid; a dispersion of the cobalt oxide microparticles; a process for producing the core-shell cobalt oxide microparticles or the cobalt oxide microparticle dispersion, which process employs a refluxing technique; and uses of the microparticles and the dispersion.

### BACKGROUND ART

Cobalt oxide is well-known as a starting material for pigments. For example, the prior-art references disclose the use of cobalt oxide as a pigment (see Patent Documents 1 and 2). If the microparticles included have a poor dispersibility, coating properties of the pigment worsen, and hence, good dispersibility of the microparticles is required.

Very fine lines and surfaces can be written by pigment coating with an ink jet. However, this requires that the microparticles present in the pigment be small. To this end, attention has been devoted to the dispersibility of nanoparticles and the like, although the tendency for such particles to aggregate generally increases at smaller particle sizes, resulting in a poor performance as a pigment.

When a dispersion of cobalt oxide microparticles is produced for the above use, a stable dispersion cannot be obtained by the conventional method of simply dispersing dried cobalt oxide microparticles in a dispersion medium. This is because the cobalt oxide microparticles aggregate, and it is necessary to break up these aggregations in order to obtain a stable dispersion.

Whether nanoparticles are synthesized by a gas phase process or a liquid phase process, they generally aggregate strongly unless aggregation is controlled following formation of the nanoparticles. Once the nanoparticles have strongly aggregated, it is generally difficult to break up the aggregations even by suitable treatment of the particles.

The prior-art reference discloses a technique for mechanically breaking up aggregations using ceramic beads (see Patent Document 3), but the problem in this case is the possibility of contamination by impurities. Moreover, a dispersant must be added to the solvent. For these reasons, cobalt oxide microparticles which easily disperse, that as, are resistant to aggregation, must be synthesized in such a way that aggregations do not have to be broken up by mechanical means or by dispersant addition.

Because nanoparticles are difficult to separate once they have aggregated, it should be possible to obtain easily dispersible cobalt oxide microparticles by treating them to control aggregation before the nanoparticles aggregate; that is, as they are being produced.

If a dispersion medium in which a polymer has been dissolved is used as the locus of the reaction in this case, aggregation can be controlled as the cobalt oxide microparticles are being produced, resulting in a stable dispersion of cobalt oxide microparticles. Moreover, even if the cobalt oxide microparticle dispersion is dried, it will probably be easy to re-disperse in a dispersion medium because it has been subjected to aggregation control treatment.

Instances where such a concept is used in a sol-gel process or a hydrolysis process have been reported (see Non-Patent Documents 1 to 4, Patent Document 4), although these reports do not relate to cobalt oxide. No cases have been found in which such a concept has been applied to a refluxing process for precipitating cobalt oxide microparticles.

A number of reports have appeared on the synthesis of cobalt oxide microparticles and nanoparticles (see Patent Documents 5 to 7). Also, ultrafine particles of metal oxide and a production process for the same, and microparticles of metal oxide have been disclosed in respective prior-art references (see Patent Documents 8 and 9). In these prior-art references, the particles are spherical secondary particles having a particle diameter of about 50 to 200 nm and a small particle diameter distribution (standard deviation of particle diameter) which are formed by the aggregation of metal oxide primary particles having a particle diameter of about 10 to 20 nm. No mention whatsoever has been made of core-shell type cobalt oxide microparticles having a good dispersibility in liquid or of core-shell type cobalt oxide microparticle dispersions.
Patent Document 1: Japanese Patent Application Laid-open No. 2007-284340
Patent Document 2: Japanese Patent Application Laid-open No. 2006-291215
Patent Document 3: Japanese Patent Application Laid-open No. 2004-35632
Patent Document 4: Japanese Patent Application Laid-open No. H2-92810
Patent Document 5: Japanese Patent Application Laid-open No. 2007-76975
Patent Document 6: Japanese Patent Application Laid-open No. 2007-1809
Patent Document 7: Japanese Patent Application Laid-open No. 2002-211930
Patent Document 8: Japanese Patent Application Laid-open No. H6-218276
Patent Document 9: Japanese Patent Application Laid-open No. 2006-8629
Non-Patent Document 1: H. Yang, C. Huang, X. Su: Materials Letters, 60 (2006) 3714.
Non-Patent Document 2: Z. T. Zhang, B. Zhao, L. M. Hu: J. Solid State Chem. 121 (1996) 105.
Non-Patent Document 3: D. L. Tao, F. Wei: Mater. Lett. 58 (2004) 3226.
Non-Patent Document 4: G. C. Xi, Y. Y. Peng, L. Q. Xu, M. Zhang, W. C. Yu, Y. T. Qian: Inorg. Chem. Commun. 7 (2004) 607.

In light of these circumstances, the inventors conducted extensive research aimed at developing a process for producing nanosize cobalt oxide microparticles which control nanoparticle aggregation and have long-term stability, and for producing dispersions of such particles. As a result, they have discovered that the use of a refluxing technique provides numerous advantages, including the ability to use an organic solvent and the absence of a need for a reaction initiator. They have also found that an inexpensive acetate may be suitably used as the starting material instead of an expensive alkoxide, thereby enabling the production of core-shell type cobalt oxide microparticles which control nanoparticle aggregation, and of a dispersion of such microparticles. Further research by the inventors ultimately led to the present invention.

### DISCLOSURE OF THE INVENTION

It is therefore an object of the present invention to provide core-shell type cobalt oxide microparticles which have a spherical shape, a particle diameter of about 50 to 200 nm and a small particle size distribution (standard deviation of particle diameter), wherein the core is a secondary particle that is spherical and of uniform size, and which has a good dispersibility in a liquid. A further object of the invention is to provide a dispersion of such cobalt oxide microparticles. Still further objects are to provide a process for producing the core-shell cobalt oxide microparticles and a dispersion of the cobalt oxide microparticles, which process applies a refluxing technique to the concept described above, and to provide uses of the microparticles and the dispersion.

To resolve the problems mentioned above, the present invention comprises the following technical means.

(1) Core-shell type cobalt oxide microparticles, characterized in that 1) a core portion thereof is a secondary particle formed by a spherical aggregation of primary particles of cobalt oxide, 2) the secondary particle is of uniform shape, 3) an organic polymer layer that forms a shell portion exists on a surface of the secondary particle, and 4) the microparticles have an average particle diameter of from 50 nm to 200 nm.
(2) The core-shell type cobalt oxide microparticles according to (1) above, wherein the organic polymer layer is composed of an organic polymer or crosslinked organic polymer of polyvinylpyrrolidone (PVP), hydroxypropyl cellulose (HPC) or polyol, does not separate from the secondary particle of the core portion even when the microparticles are subjected to rinsing, and is present in a proportion of from 10 wt % to 20 wt %.
(3) The core-shell type cobalt oxide microparticles according to (1) above, wherein the primary particles have a diameter of from 10 to 20 nm and the secondary particle has a diameter coefficient of variation of 0.2 or less.
(4) A core-shell type cobalt oxide microparticle powder as a dry powder containing the core-shell type cobalt oxide microparticles defined in any one of (1) to (3) above, which has a quality of dispersing well in a dispersion medium to which dispersant is not added.
(5) A core-shell type cobalt oxide microparticle dispersion comprising the core-shell type cobalt oxide microparticles defined in any one of (1) to (3) above, or the core-shell type cobalt oxide microparticle powder defined in (4) above, which is dispersed in a dispersion medium.
(6) The core-shell type cobalt oxide microparticle dispersion according to (5) above, wherein the dispersion medium is any one of water, ethanol, terpineol and ethylene glycol, or a mixed solution of a plurality thereof.
(7) A pigment comprising the microparticles defined in any one of (1) to (3) above, the microparticle powder defined in (4) above, or the microparticle dispersion defined in (5) or (6) above.
(8) A process for producing core-shell type cobalt oxide microparticles, a cobalt oxide microparticle powder or a cobalt oxide microparticle dispersion, which is a process for producing the core-shell type cobalt oxide particles, cobalt oxide microparticle powder or cobalt oxide microparticle dispersion defined in any one of (1) to (6) above, comprising the steps of:

mixing together a cobalt salt, an organic polymer and distilled water in a high-boiling-point organic solvent so as to obtain a mixture;

and heating/refluxing the mixture at a temperature of at least 190° C. so as to cause the cobalt oxide microparticles to precipitate.

(9) The process for producing cobalt oxide microparticles, a cobalt oxide microparticle powder or a cobalt oxide microparticle dispersion according to (8) above, wherein the cobalt salt is cobalt acetate, the organic polymer is polyvinylpyrrolidone (PVP), hydroxypropyl cellulose (HPC) or polyethylene glycol (PEG), and the high-boiling-point organic solvent is diethylene glycol (DEG).
(10) The process for producing cobalt oxide microparticles, a cobalt oxide microparticle powder or a cobalt oxide microparticle dispersion according to (8) or (9) above, wherein the organic polymer has a concentration (weight of organic polymer added per unit volume of organic solvent) of from 100 kg/m³ to 140 kg/m³.
(11) The process for producing cobalt oxide microparticles, a cobalt oxide microparticle powder or a cobalt oxide microparticle dispersion according to (8) or (9) above, wherein the organic polymer has a polyethylene glycol-equivalent average molecular weight of from 4,000 to 5,000, or the cobalt salt has a concentration of from 0.05 kmol/m³ to 0.20 kmol/m³.
(12) The process for producing cobalt oxide microparticles, a cobalt oxide microparticle powder or a cobalt oxide microparticle dispersion according to (8) or (9) above, wherein the distilled water is added in a volumetric ratio with respect to the high-boiling-point organic solvent of at least 0.016.

The invention is described below in greater detail.

The present invention is directed at core-shell type cobalt oxide microparticles characterized in that the core portion thereof becomes a secondary particle formed by the spherical aggregation of primary particles of the cobalt oxide, which secondary particle is of uniform shape, a layer of organic polymer which constitutes the shell portion is formed on the surface of the secondary particle, and the microparticles have an average particle diameter of from 50 nm to 200 nm. The invention is also directed at a dry powder containing such core-shell type cobalt oxide microparticles, which powder is characterized by having the quality of dispersing well in a dispersion medium to which dispersant is not added. The invention is additionally directed at a dispersion of the core-shell type cobalt oxide particles, which dispersion is obtained by dispersing the core-shell type cobalt oxide microparticles or the dry powder of core-shell type cobalt oxide microparticles in a dispersion medium.

As used herein, a core-shell type cobalt oxide microparticle is defined as referring to a microparticle in which a secondary particle formed by the spherical aggregation of primary particles of cobalt oxide has on the surface thereof a layer of organic polymer (see FIG. 1). This core-shell type cobalt oxide particle differs from a particle composed of a polymer present on the surface of a primary particle or a secondary particle of irregularly aggregated primary particles.

A prior-art reference (Japanese Patent Application Laid-open No. 2006-8629) discloses a composite particle composed of a polymeric compound coated on the surface of a primary particle or an agglomerate. However, this primary particle or agglomerate is not spherical, having an irregular shape. The reason is that, in the production method disclosed in the aforementioned document, the metal oxide microparticles which have been synthesized beforehand are dispersed or disintegrated using a dispersing apparatus such as a bead mill.

In this dispersion step, the primary particles or primary particle agglomerates are disintegrated, but the primary particle agglomerates following disintegration cannot be made spherical and given a uniform size as in the case of the core-shell type cobalt oxide particles of the present invention. Moreover, the content of the coated polymer is indicated in the above document as being at least 25 wt %. By contrast, in the present invention, as subsequently mentioned, the polymer content is from 10 to 20 wt %; hence, the layer of organic polymer accounts for less than 25 wt %. This is because the organic polymer which readily detaches has been removed by rinsing. This too is a major difference with the composite particles of the above document.

The inventive core-shell type cobalt oxide microparticles having an average particle diameter of from 50 nm to 200 nm are characterized in that a secondary particle of the core portion has a spherical shape and is uniform in size, and the organic polymer serving as the shell portion is attached to the surface of the cobalt oxide secondary particle.

The core-shell type cobalt oxide microparticle dispersion of the invention is characterized by being composed of core-shell type cobalt oxide microparticles dispersed in a dispersion medium. Moreover, the core-shell type cobalt oxide microparticle powder of the invention is characterized by having the quality of dispersing well in a dispersion medium to which dispersant is not added.

Furthermore, the core-shell type cobalt oxide microparticle production process of the invention is characterized by including the steps of mixing together a cobalt salt and an organic polymer in a high-boiling-point organic solvent so as to obtain a mixture, and heating/refluxing the mixture at a temperature of at least 190° C. so as to cause the cobalt oxide microparticles to precipitate and to induce an organic polymer crosslinking reaction. In a preferred embodiment of this invention, the cobalt salt is cobalt acetate.

As used herein, a core-shell type cobalt oxide microparticle dispersion refers to a dispersion obtained by dispersing the core-shell type cobalt oxide microparticles as the dispersoid in a dispersion medium. This dispersion may alternatively be referred to as a suspension or a sol. In cases where the concentration of microparticles is high, the dispersion may be called as a paste.

First, the process for producing the core-shell type cobalt oxide microparticles of the invention is described. The starting materials are cobalt acetate, a high-boiling-point organic solvent, distilled water and an organic polymer. Of these, the cobalt acetate may be a commercially available substance, and is generally a hydrate.

To obtain metal ion-doped cobalt oxide microparticles, a metal salt is added in addition to the cobalt acetate. High-boiling-point organic solvents include diethylene glycol (DEG) and glycerin. DEG is more preferred. Also, the organic polymer is preferably one that dissolves in the organic solvent. Examples include polyvinylpyrrolidone (PVP), hydroxypropyl cellulose (HPC) and polyethylene glycol (PEG). PVP is more preferred.

These starting materials are mixed and dissolved. In this step, a cobalt salt, an organic polymer and distilled water are mixed in a high-boiling-point organic solvent so as to obtain a mixture. The concentration of cobalt acetate at this time is preferably from 0.05 to 0.2 kmol/m³. The organic polymer concentration is preferably from 100 kg/m³ to 140 kg/m³.

As used herein, an organic polymer concentration is defined as the weight of organic polymer added per unit volume of solvent. The reason for setting the organic polymer concentration in a range of from 100 kg/m³ to 140 kg/m³ is that below this range, the dispersibility may worsen. On the other hand, if the organic polymer concentration is higher than this range, it may not be possible to obtain spherical cobalt oxide microparticles. Also, distilled water is added to increase the concentration of the cobalt oxide microparticles obtained. The distilled water is added in a volumetric ratio with respect to the high-boiling-point organic solvent of preferably at least 0.016.

Next, the above mixture is heated/refluxed at a temperature of at least 190° C. This is a step in which the cobalt oxide is precipitated by heating and refluxing at a predetermined temperature. Generally, an alkali such as sodium hydroxide or ammonia is added when inducing an oxide to precipitate. However, this invention is characterized in that such addition is not necessary. By adding sodium hydroxide or the like, the nanoparticles ultimately obtained may be contaminated with sodium. In this invention, because there is no need for alkalis and the like, contamination by such impurities is unlikely to occur.

The heating/refluxing time is at least 300 minutes. At a short heating/refluxing time, there is a possibility that a large amount of unreacted cobalt ions will remain. During heating and refluxing, the liquid mixture becomes cloudier. Heating/refluxing is carried out for a predetermined time and is followed by cooling. In this way, there can be obtained a core-shell type cobalt oxide microparticle dispersion of core-shell type cobalt oxide microparticles dispersed in an organic solvent within which an organic polymer has been dissolved. The mechanism by which the core-shell type cobalt oxide microparticles form is thought to be as follows.

1. Primary particles of cobalt oxide nucleate in the high-boiling-point organic solvent (polyol) containing a uniformly dissolved organic polymer.
2. The primary particles spherically aggregate. The primary particles continually nucleate at this time as well.
3. The nucleated primary particles gather spherically at the surface of an agglomerate (secondary particle).
4. At this time, with the cobalt oxide acting as a catalyst at the surface of the secondary particle, the organic polymer and/or organic solvent gives rise to crosslinking reactions, resulting in the formation of a strong organic polymer layer.
5. When the strong organic polymer layer has fully developed, aggregation ceases to occur, giving a core-shell type cobalt oxide microparticle.

In the present invention, the core-shell type cobalt oxide microparticles are defined as particles characterized by having a core portion that is a secondary particle formed by the spherical aggregation of primary particles of cobalt oxide, which secondary particle is of a uniform shape, and a shell portion composed of a layer of organic polymer on the surface of the secondary particle, and by having an average particle diameter of from 50 nm to 200 nm.

The organic polymer layer serving as the shell portion is composed of polyvinylpyrrolidone (PVP), hydroxypropyl cellulose (HPC), a polyol such as polyethylene glycol (PEG) or diethylene glycol (DEG), or a related organic polymer. Here, a related organic polymer is exemplified by organic polymers formed by the mutual crosslinking of PVP, organic polymers formed by the mutual crosslinking of HPC, organic polymers formed by crosslinking PVP or HPC with a polyol and organic polymers formed by the mutual crosslinking of polyols, and encompasses various types of such organic polymers.

Heat is thought to be required for cobalt oxide to trigger catalytic activity. This is why heating/refluxing at a temperature of at least 190° C. is necessary. In cases where the heating/refluxing temperature is low, even if primary particles have formed, they will not become core-shell type particles. If the primary particles do not aggregate, formation of the inventive core-shell type cobalt oxide microparticles will not occur.

In such a case, because a large amount of unreacted organic polymer is present, vaporizing the solvent will result in the formation of a cobalt oxide-polymer composite composition made up of primary particles which remain within a polymer matrix. This clearly differs from core-shell type cobalt oxide microparticles.

Even if aggregation should arise in this case, because there are no catalyst reactions at the cobalt oxide surface, an organic polymer layer is unable to form, resulting in aggregated particles of irregular shape. This type of metal oxide-polymer composite composition is disclosed in a prior-art document (Japanese Patent Application Laid-open No. H6-218276), but differs fundamentally from the present invention.

As shown in the subsequently described working examples of the invention, because core-shell type cobalt oxide microparticles do not form below some critical temperature, heating/refluxing at an elevated temperature is essential. In the core-shell type cobalt oxide microparticle dispersion obtained right after such heating and refluxing, the dispersion medium is the organic solvent used in heating and refluxing. For example, if heating and refluxing is carried out with diethylene glycol (DEG), the dispersion medium is DEG.

If there is a desire to change the dispersion medium to some other dispersion medium, this may be done by replacing the dispersion medium with another dispersion medium. Such dispersion medium substitution may be carried out by, for example, using a technique such as centrifugal separation to separate the dispersion medium and the dispersoid, removing the dispersion medium, and adding the desired dispersion medium. At this time, the organic polymer forming the shell portion can not be separated off with rinsing, and is inseparable from the core.

Some of the organic polymer used in the heating/refluxing is thought to remain in the dispersion medium, in addition to which unreacted cobalt ions are also thought to remain. The excess organic polymer may be removed by repeatedly carrying out centrifugal separation and solvent substitution. The core-shell type cobalt oxide microparticles acting as the dispersoid in the dispersion obtained by the above-described method are spherical. A particle diameter refers herein to the diameter of the core-shell type cobalt oxide microparticles, as determined by scanning electron microscopic (SEM) observation.

The secondary particle that forms the core portion is an aggregation of primary particles, and is also sometimes called as a primary agglomerate. The primary particle diameter is from 10 to 20 nm. Each individual spherical cobalt oxide microparticle serving as a core portion is a secondary particle, not a primary particle. The cobalt oxide microparticles may be doped with metallic ions having a valence of from 1 to 5. Metallic ions such as sodium, calcium, yttrium, gadolinium, zirconium, hafnium and niobium may be used for such doping.

A collection of secondary particles (microparticles) that have aggregated is sometimes called as a secondary agglomerate. The refractive index and viscosity of the dispersion medium are necessary in the dynamic light scattering (DLS) method. A value described in a literature may be used as the refractive index of the dispersion medium. On the assumption that the viscosity of the dispersion medium is identical with the viscosity of the dispersion, the value obtained by measuring the viscosity of the dispersion is employed.

In this way, the average particle diameter (dₐ) and the standard deviation (s) are determined, from which the coefficient of variation c (=s/dₐ) is calculated. A dry powder can be obtained by subjecting the dispersion prepared as described above about three times to centrifugal separation and re-dispersion in water or ethanol, followed by drying at, e.g., 80° C. The dry powder is examined with a SEM, and the shape of the particles as well as the average particle diameter and standard deviation are determined.

The core-shell type cobalt oxide microparticles have an average particle diameter of from 50 nm to 200 nm. Moreover, shell-core type cobalt oxide microparticles of uniform particle diameter, i.e., having a small particle diameter coefficient of variation, can be obtained. The coefficient of variation in this case is 0.20 or less, and sometimes about 0.10. This can be confirmed by SEM observation of the dry powder. Also, the particle diameter in the dispersion medium is not more than twice that of the core-shell type cobalt oxide microparticles. This indicates that the core-shell type cobalt oxide microparticles are present within the dispersion medium in a substantially unaggregated state.

An organic polymer layer is, of course, present as the shell portion on the surface of the core-shell type cobalt oxide microparticles. This can be investigated and confirmed for the above dry powder by Fourier transform infrared spectrophotometric (FTIR) analysis and thermogravimetric (TG) analysis. The above-described dry powder is subjected about three times to centrifugal separation and re-dispersion in water or ethanol, following which excessive organic polymer not associated with the core-shell type cobalt oxide microparticles is removed. Because of the drying carried out, the dispersion medium is also fully removed. The organic polymer layer is present in a content of preferably from 10 to 20 wt %.

The absorption peaks other than for cobalt oxide which are observable in Fourier transform infrared spectrophotometry (FTIR) arise from what is present at the surface of the cobalt oxide microparticles. The fact that such absorption peaks resemble absorption by the organic polymer, together with the existence of a weight change at temperature above the boiling point of the dispersion medium, leads to the conclusion that organic polymer is attached to the surface of the cobalt oxide microparticles.

Here, the organic polymer is preferably PVP, HPC, an organic polymer formed by the mutual crosslinking of PVP, an organic polymer formed by the mutual crosslinking of HPC, an organic polymer obtained by the crosslinking of PVP or HPC with a polyol, an organic polymer obtained by the mutual crosslinking of polyols, or a product obtained by the reaction of any of the above with cobalt oxide.

The dry powder easily disperses even when re-dispersed in a dispersion medium. This is a property that differs from ordinary powders. In general, once a powder is dried, it strongly aggregates; as a result, even when an attempt is made to re-disperse the powder, it does not easily disperse. However, the dry powder of the invention can be easily dispersed using only an ultrasonic homogenizer; that is, a dispersant is not required. The dispersion medium in this case may be any suitable dispersion medium. Preferred example is any one of water, ethanol, terpineol and ethylene glycol, and mixed solutions obtained by mixing a plurality thereof.

The invention achieves the following effects.

(1) It can provide core-shell type cobalt oxide microparticles having a particle diameter of about 50 nm to 200 nm, a spherical shape and a good dispersibility in liquids, and a dispersion of such microparticles.

(2) It can provide a dry powder of core-shell type cobalt oxide microparticles that readily re-disperse.

(3) It can provide a dispersion of core-shell type cobalt oxide microparticles dispersed in any dispersion medium.

(4) It can provide high-viscosity core-shell type cobalt oxide microparticle dispersions, i.e., core-shell type cobalt oxide microparticle pastes.

(5) It can provide a simple process for producing core-shell type cobalt oxide microparticles and for producing a dispersion of such cobalt oxide microparticles.

(6) It can obtain a high-concentration cobalt oxide microparticle dispersion.

(7) It can provide a pigment which is high-resolution printable or writable by means of an ink jet or the like.

### BRIEF DESCRIPTION OF THE DRAWINGS

FIG. 1 shows a schematic diagram of a core-shell structure.

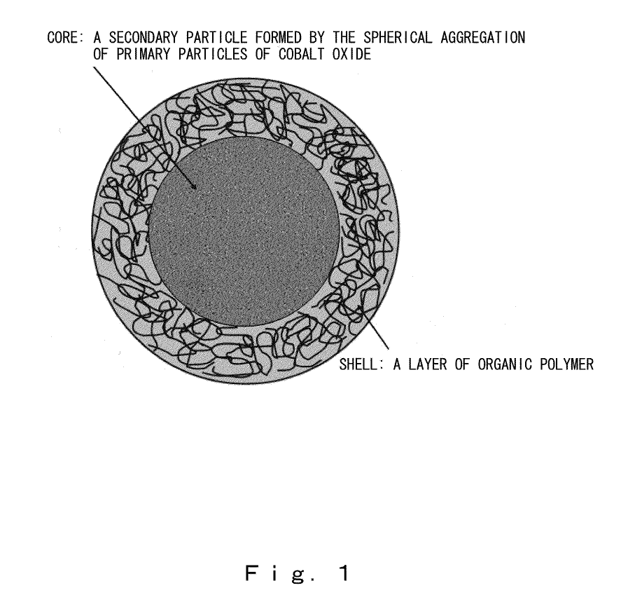

FIG. 2 shows a SEM of the dry powder of Example 1.

FIG. 3 shows an x-ray diffraction pattern for the dry powder of Example 1.

FIG. 4 shows an IR spectrum of the dry powder in Example 1.

FIG. 5 shows a thermogravimetric plot for the dry powder in Example 1.

### BEST MODE FOR CARRYING OUT THE INVENTION

Working examples of the invention are given below by way of illustration, although the invention is in no way limited by these examples.

### Example 1

Water, polyvinylpyrrolidone (PVP; Sigma-Aldrich) and Co(CH₃COO)₂.4H₂O (cobalt acetate tetrahydrate; Wako Pure Chemical Industries) were added to 30 cm³ of diethylene glycol (DEG; Wako Pure Chemical Industries) and stirred. The water was added in an amount of 0.017 cm³ per cm³ of DEG. The concentration of polymer added was 120 kg/m³. The PVP had an average molecular weight (catalog value) of 10,000, and a polyethylene glycol-equivalent average molecular weight of from 4,000 to 5,000. The concentration of Co(CH₃COO)₂.4H₂O was 0.10 kmol/m³ (1 kmol/m³=1 mol/L).

Heat was applied to the above mixture, which was heated/refluxed at 200° C. for 360 minutes. The mixture was then cooled, giving a core-shell type cobalt oxide microparticle dispersion. To remove unreacted material and excess PVP, the dispersion was subjected to centrifugal separation at 18,000 rpm, then rinsed with water and ethanol. After rinsing, drying was carried out at 80° C., giving a powder. The dry powder was examined with a SEM, and the particle size distribution was determined from the resulting images.

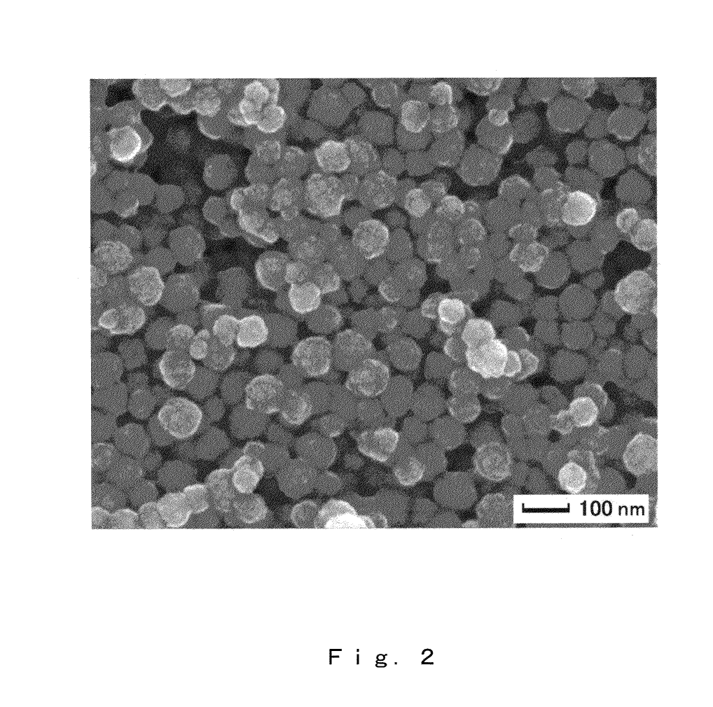

FIG. 2 shows an SEM image of the dry powder. Spherical microparticles were observed. The particle diameter determined from the SEM image was 81.1 nm, and the coefficient of variation was 0.166. The microparticles were confirmed to be of uniform diameter and monodispersed.

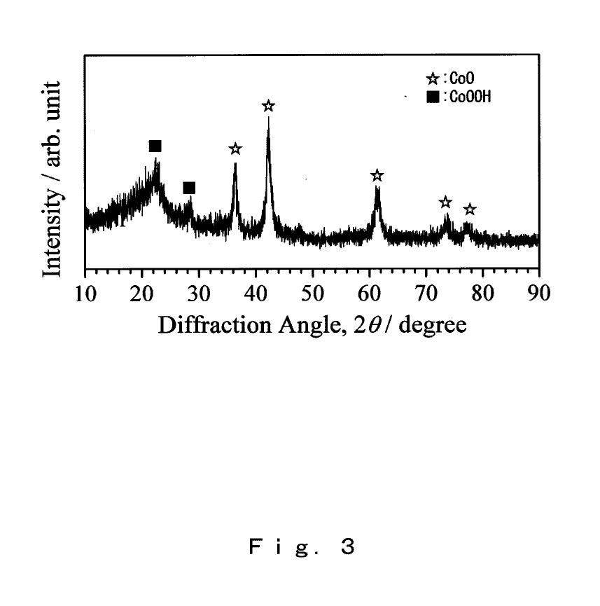

FIG. 3 shows the X-ray diffraction pattern for the dry powder. This is the diffraction pattern of a NaCl structure, confirming that the powder was cobalt oxide. Cobalt oxide was confirmed to be present in the microparticles within the dispersion right after refluxing, and in the dry powder. However, CoOOH peaks were also confirmed, indicating that the dry powder was not an oxide monophase. The crystallite diameter was calculated from the diffraction peak widths, and confirmed to be from 12 to 14 nm.

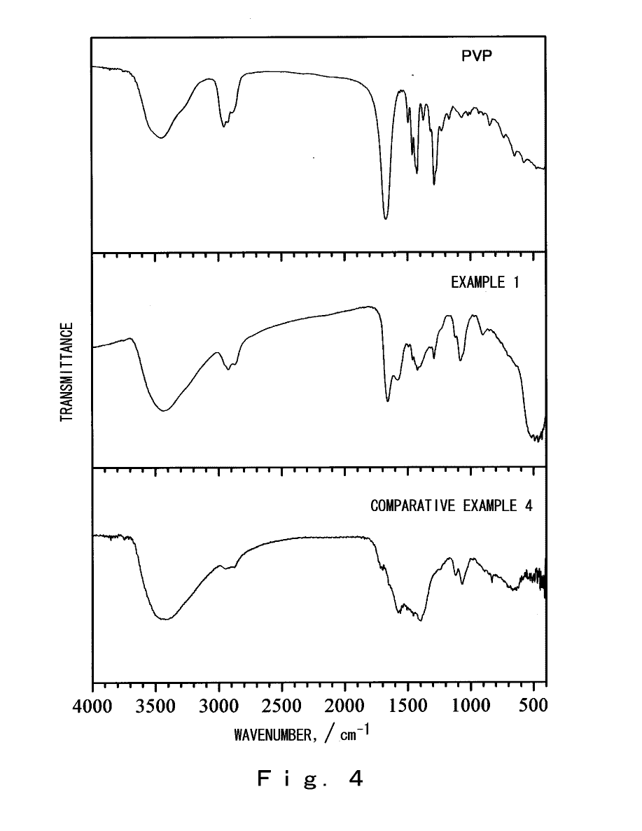

FIG. 4 shows the IR spectrum of the dry powder obtained in this example. Also shown here is the IR spectrum for the dry powder obtained in Comparative Example 4, which is subsequently described. In Comparative Example 4, PVP and water were not added at the time of the synthesis described in Example 1, and synthesis was carried out at a refluxing/heating temperature of 180° C. FIG. 4 additionally shows the IR spectrum for PVP. An absorption peak was observed at from 1600 to 1700 cm⁻¹ in the IR spectrum for the dry powder of Example 1.

On the other hand, an absorption peak was not observed in the IR spectrum for the dry powder in Comparative Example 4. Because an absorption peak is observable at from 1600 to 1700 cm⁻¹ in the IR spectrum for PVP as well, the peak at from 1600 to 1700 cm⁻¹ observed in Example 1 but not observed in Comparative Example 4 was confirmed to be an absorption peak associated with PVP.

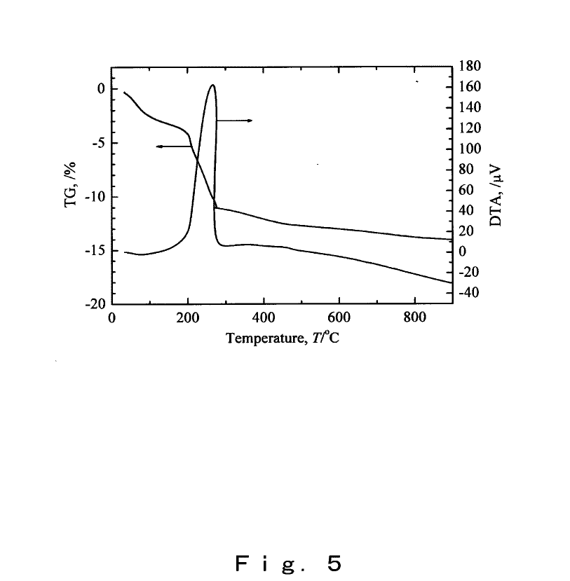

The results of TG analysis are shown in FIG. 5. When the temperature was raised to 900° C., the weight decreased by 14%. Judging overall from the FTIR and the TG results, either PVP or an organic polymer related to PVP is present in the microparticles of Example 1. As a result, the microparticles obtained in Example 1 were confirmed to be core-shell type cobalt oxide microparticles having a cobalt oxide core and an organic polymer shell.

The dispersion stabilities in water were investigated for a dispersion of the dry powder of Example 1 re-dispersed in water and for a dispersion of the dry powder of Comparative Example 5 re-dispersed in water. Comparative Example 5 is described subsequently in greater detail. Here, 0.02 g of the dry powder of Example 1 or Comparative Example 5 was dispersed in 2 cm³ of water, and the manner in which precipitation occurred in the dispersion was observed.

Because precipitate remained in both samples even after 3 minutes of treatment in an ultrasonic homogenizer (output, 9.5), the samples were shaken by hand, then again subjected to ultrasonic treatment (output, 9.5), this time for 6 minutes. As a result, a little precipitate was present in the Example 1 sample, but the liquid had a brown turbidity, indicating that re-dispersion had occurred. However, in Comparative Example 5, precipitation quickly occurred, as a result of which most of the sample formed a clear phase; that is, substantially no re-dispersion occurred.

The proportion of precipitate in the re-dispersed sample in Example 1 was increased by letting the sample stand for one day, but the sample also included dispersed material. In Comparative Example 5, the precipitated phase and the clear phase separated completely. It was found from these results that the re-dispersion behavior clearly differs in microparticles obtained by adding PVP (Example 1) as opposed to microparticles not obtained in this way (Comparative Example 5), with re-dispersion in Example 1 being easy.

### Examples 2 and 3

As Examples 2 and 3, experiments were carried out under exactly the same conditions as in Example 1. In both of these examples, the core of the microparticles obtained was cobalt oxide (although, as mentioned also in Example 1, a little CoOOH was present), and the microparticles were spherical in shape. The particle diameters in Examples 2 and 3 were respectively 57.2 and 65.5 nm. The coefficients of variation in Examples 2 and 3 were respectively 0.137 and 0.105. The X-ray diffraction patterns and the IR spectra were substantially the same as in Example 1. On the basis of these results, the reproducibility of the microparticles was confirmed to be good.

### Comparative Example 1

In Comparative Example 1, an experiment was carried out based on Example 1 (aside from the following condition, this was the same as in Example 1), but at a heating/refluxing temperature lowered to 180° C. Only a small amount of microparticles was obtained. It was apparent from SEM examination that the microparticles obtained were not spherical particles. As a result, it was found that when the heating/refluxing temperature is not higher than 180° C., spherical microparticles cannot be obtained.

### Comparative Example 2

In Comparative Example 2, an experiment was carried out based on Example 1 (aside from the following condition, this was the same as in Example 1), but without the addition of water (distilled water). Here too, as in Comparative Example 1, only a small amount of microparticles was obtained. It was apparent from SEM examination that the microparticles obtained were not spherical particles. As a result, it was found that when water is not added, spherical microparticles cannot be obtained.

### Comparative Example 3

In Comparative Example 3, an experiment was carried out based on Example 1 (aside from the following conditions, this was the same as in Example 1), but at a heating/refluxing temperature lowered to 180° C. and without the addition of water (distilled water). Here too, as in Comparative Example 1, only a small amount of microparticles was obtained. It was apparent from SEM examination that the microparticles obtained were not spherical particles.

### Comparative Example 4

In Comparative Example 4, an experiment was carried out based on Comparative Example 1 (aside from the following condition, this was the same as in Comparative Example 1), but without the addition of PVP. In this case, many particles were obtained. However, it was apparent from SEM examination that the particles were not spherical. Also, as a result of X-ray diffraction analysis, the particles were found to be non-crystalline. Moreover, the IR spectrum had no absorption peak near 1600 to 1700 cm⁻¹, which was a result that clearly differed from that in Example 1.

### Comparative Example 5

In Comparative Example 5, an experiment was carried out based on Example 1 (aside from the following condition, this was the same as in Example 1), but without the addition of PVP.

Here too, as in Comparative Example 4, many particles were obtained. However, it was apparent from SEM examination that the particles were not spherical. From these results, it was found that when PVP was not included, spherical particles were not obtained. When a re-dispersion in water experiment was carried out, the particles soon precipitated. This was because the agglomerates were large and readily precipitated.

### INDUSTRIAL APPLICABILITY

As described in detail above, the present invention relates to core-shell type cobalt oxide microparticles, a dispersion containing such microparticles, and a production process and uses of the microparticles and the dispersion. According to this invention, there can be provided core-shell type cobalt oxide microparticles having a particle diameter of from about 50 nm to 200 nm, a spherical shape and good dispersibility in water, and there can also be provided a dispersion of such microparticles. The present invention is also able to provide a core-shell type cobalt oxide microparticle dispersion or a pigment which contains such a cobalt oxide particle dispersion. This invention is useful in that it provides core-shell type cobalt oxide microparticles which are spherical, which have a particle diameter of about 50 to 200 nm and a small particle diameter distribution (standard deviation of particle diameter), wherein the secondary particles that form the core portion are also spherical and of uniform size, and which have a good dispersibility in liquid; and is useful also in that it provides a process for producing such core-shell type cobalt oxide microparticles and such a cobalt oxide microparticle dispersion, which process employs a refluxing technique, and further provides uses of such microparticles and for such a microparticle dispersion.

1. Core-shell type cobalt oxide microparticles, characterized in that 1) a core portion thereof is a secondary particle formed by a spherical aggregation of primary particles of cobalt oxide, 2) the secondary particle is of uniform shape, 3) an organic polymer layer that forms a shell portion exists on a surface of the secondary particle, and 4) the microparticles have an average particle diameter of from 50 nm to 200 nm.

2. The core-shell type cobalt oxide microparticles according to claim 1, wherein the organic polymer layer is composed of an organic polymer or crosslinked organic polymer of polyvinylpyrrolidone (PVP), hydroxypropyl cellulose (HPC) or polyol, does not separate from the secondary particle of the core portion even when the microparticles are subjected to rinsing, and is present in a proportion of from 10 wt % to 20 wt %.

3. The core-shell type cobalt oxide microparticles according to claim 1, wherein the primary particles have a diameter of from 10 to 20 nm and the secondary particle has a diameter coefficient of variation of 0.2 or less.

4. A core-shell type cobalt oxide microparticle powder as a dry powder containing the core-shell type cobalt oxide microparticles defined in any one of claims 1 to 3, which has a quality of dispersing well in a dispersion medium to which dispersant is not added.

5. A core-shell type cobalt oxide microparticle dispersion comprising the core-shell type cobalt oxide microparticles defined in any one of claims 1 to 3, or the core-shell type cobalt oxide microparticle powder defined in claim 4, which is dispersed in a dispersion medium.

6. The core-shell type cobalt oxide microparticle dispersion according to claim 5, wherein the dispersion medium is any one of water, ethanol, terpineol and ethylene glycol, or a mixed solution of a plurality thereof.

7. A pigment comprising the microparticles defined in any one of claims 1 to 3, the microparticle powder defined in claim 4, or the microparticle dispersion defined in claim 5 or 6.

8. A process for producing core-shell type cobalt oxide microparticles, a cobalt oxide microparticle powder or a cobalt oxide microparticle dispersion, which is a process for producing the core-shell type cobalt oxide particles, cobalt oxide microparticle powder or cobalt oxide microparticle dispersion defined in any one of claims 1 to 6, comprising the steps of:
mixing together a cobalt salt, an organic polymer and distilled water in a high-boiling-point organic solvent so as to obtain a mixture;
and heating/refluxing the mixture at a temperature of at least 190° C. so as to cause the cobalt oxide microparticles to precipitate.

9. The process for producing cobalt oxide microparticles, a cobalt oxide microparticle powder or a cobalt oxide microparticle dispersion according to claim 8, wherein the cobalt salt is cobalt acetate, the organic polymer is polyvinylpyrrolidone (PVP), hydroxypropyl cellulose (HPC) or polyethylene glycol (PEG), and the high-boiling-point organic solvent is diethylene glycol (DEG).

10. The process for producing cobalt oxide microparticles, a cobalt oxide microparticle powder or a cobalt oxide microparticle dispersion according to claim 8 or 9, wherein the organic polymer has a concentration (weight of organic polymer added per unit volume of organic solvent) of from 100 kg/m³ to 140 kg/m³.

11. The process for producing cobalt oxide microparticles, a cobalt oxide microparticle powder or a cobalt oxide microparticle dispersion according to claim 8 or 9, wherein the organic polymer has a polyethylene glycol-equivalent average molecular weight of from 4,000 to 5,000, or the cobalt salt has a concentration of from 0.05 kmol/m³ to 0.20 kmol/m³.

12. The process for producing cobalt oxide microparticles, a cobalt oxide microparticle powder or a cobalt oxide microparticle dispersion according to claim 8 or 9, wherein the distilled water is added in a volumetric ratio with respect to the high-boiling-point organic solvent of at least 0.016.
